(19) United States
(12) Patent Application Publication
(10) Pub. No.: US 2007/0130403 A1
(43) Pub. Date: Jun. 7, 2007

(54) Apparatus, method and computer program product providing data serializing by direct memory access controller

(75) Inventors: Franziskus Bauer, Koln (DE); Erwin Hemming, Herne (DE); Oliver Luert, Bochum (DE); Dirk Tiegelbekkers, Essen (DE); Daniel Wernet, Bochum (DE)

Correspondence Address: HARRINGTON & SMITH, PC, 4 RESEARCH DRIVE, SHELTON, CT, 06484-6212, US

(73) Assignee: Nokia Corporation

(21) Appl. No.: 11/544,178

(22) Filed: Oct. 6, 2006

Related U.S. Application Data
(60) Provisional application No. 60/735,755, filed on Nov. 9, 2005.

(51) Int. Cl. G06F 13/38

(52) U.S. Cl. 710/71

(57) ABSTRACT

A method includes constructing a data unit including a plurality of parts stored in a plurality of regions of a memory, and instructing a controller to serialize the data unit and to transfer the data unit to a destination.

### CROSS REFERENCE TO RELATED APPLICATION

This Application claims the benefit under 35 USC 119(e) of U.S. Provisional Application No. 60/735,755 filed Nov. 9, 2005.

### TECHNICAL FIELD

The exemplary and non-limiting embodiments of this invention relate generally to data processors and data transfer techniques and, more specifically, relate to direct memory access (DMA) data transfer techniques and associated DMA control circuits.

### BACKGROUND

The following abbreviations are herewith defined:
Risc Reduced instruction set computer
ARM Advanced Risc Machine
BB Baseband (digital circuitry)
DMA Direct Memory Access
RAM Random Access Memory (read/write)
Tx Transmit
Rx Receive
MAC Medium Access Control
PDCP Packet Data Convergence Protocol
RRC Radio Resource Control
RLC Radio Link Controller
RNC Radio Network Controller
PHY Physical layer (Layer 1 or L1)
L2 Layer 2
UL2 Upper Layer 2 (upper part of split protocol stack, e.g., RLC, PDCP)
LL2 Lower Layer 2 (lower part of split protocol stack, e.g., MAC)
RF Radio Frequency
HW Hardware
SW Software
SDU Service Data Unit
UE User Equipment
Node B Base Station

Data are typically transferred over one or more busses from a data processor to hardware. In general, when utilizing direct memory access (DMA), hardware devices can access main memory without the involvement of a central processing unit (CPU). If a DMA technique is used, the data stored in a memory may have to be first sorted and copied by the data processor before it is made available to a DMA port. This sorting and copying operation may consume a considerable amount of the processing capabilities of the data processor, and is thus undesirable from a number of viewpoints. For example, in portable battery-powered devices such as cellular phones, personal digital assistants, gaming devices and digital cameras, to name just a few such devices, the data processor bandwidth may be limited. In addition, data processor operations, such as data sorting and copying, consume battery power. Further, it is often the case that processor response is time critical, such as in modem wireless communication systems such as 3.9G systems, (Release 8 of UTRA (EUTRA)) and thus the mundane sorting and copying operations can reduce the responsivity of the data processor to time critical operations.

### SUMMARY

The foregoing and other problems are overcome, and other advantages are realized, in accordance with the exemplary embodiments of these teachings.

In accordance with an exemplary embodiment of the invention, a method includes constructing a data unit including a plurality of parts stored in a plurality of regions of a memory, and instructing a controller to serialize the data unit and to transfer the data unit to a destination.

In accordance with another exemplary embodiment of the invention, a method includes receiving an instruction to serialize a data unit comprising a plurality of parts stored in a plurality of regions of a memory, serializing the data unit, and transferring the data unit to a destination.

In accordance with another exemplary embodiment of the invention, an apparatus includes a processor and a memory coupled to the processor for storing a set of instructions, executable by the processor, for constructing a data unit comprising a plurality of parts stored in a plurality of regions of a memory, and instructing a controller to serialize the data unit and to transfer the data unit to a destination.

In accordance with another exemplary embodiment of the invention, a program of machine-readable instructions, tangibly embodied on an information bearing medium and executable by a digital data processor, performs actions including constructing a data unit comprising a plurality of parts stored in a plurality of regions of a memory, and instructing a controller to serialize the data unit and to transfer the data unit to a destination.

In accordance with another exemplary embodiment of the invention, a network element includes a processor and a memory coupled to the processor for storing a set of instructions, executable by the processor, for constructing a data unit comprising a plurality of parts stored in a plurality of regions of a memory, and instructing a controller to serialize the data unit and to transfer the data unit to a destination.

In accordance with another exemplary embodiment of the invention, a method includes constructing at least two data blocks locate din different regions of a memory, programming a controller with a control information and memory location and length information of the at least two data blocks, and instructing the controller to perform a data transfer of the at least two data blocks in a predetermined sequence.

### BRIEF DESCRIPTION OF THE DRAWINGS

In the attached Drawing Figures:

FIG. 1 is a simplified block diagram of an exemplary system hardware structure that includes a processor, a DMA controller and Baseband circuitry, such as may be found in a wireless communications device;

FIG. 2 illustrates an operation of serializing a Header and Payload (SDU) by a DMA controller according to an exemplary embodiment of the invention;

FIG. 3 shows a simplified block diagram of various electronic devices that are suitable for use in practicing exemplary embodiments of the invention;

FIG. 4 shows an example of a more complex “instruction set” to the DMA controller of FIG. 1, including pointers to several MAC headers and SDUs in a memory according to an exemplary embodiment of the invention;

FIG. 5 depicts an exemplary embodiment of the invention where the DMA controller of FIG. 1 is used for processor data intercommunication in a receiving direction;

FIG. 6 is a diagram that contrasts a conventional processor-based memory sorting operation with the DMA controller-based technique in accordance with exemplary embodiments of the invention for serializing data to be transmitted; and

FIG. 7 is a flow chart of a method according to an exemplary embodiment of the invention.

### DETAILED DESCRIPTION

By way of introduction, the exemplary embodiments of this invention pertain generally to a data processor, such as embedded data processor, and data processor access techniques, such as those to and from dedicated hardware blocks. While the exemplary embodiments of this invention provide hardware and software techniques usable for the framing and deframing of data units, such as MAC protocol units for a wireless communication system, it should be appreciated that the exemplary embodiments of this invention may be employed in a number of different types of systems and for other uses. In general, the exemplary embodiments of this invention improve the data handling capacity between a data processor and other hardware, and serve to also decrease the load on the data processor for data handling operations, such as data serialization and sorting/copying data handling operations as two non-limiting examples.

As employed herein “serialization” of data implies an ordering of memory data for subsequent processing by other HW and/or by SW elements as a data stream.

In accordance with exemplary embodiments of this invention, in order to avoid requiring the data processor to move data within a memory during a data sorting operation, the data processor instead simply provides the DMA controller with a list of the data fields that are to be transferred, after which the DMA controller is responsible for transferring the data and, in so doing, performs the data sorting and reorganization operation. This provides the data processor with more time to perform useful computations, as the mundane data sorting task prior to moving a block of data is offloaded to the DMA controller. This further enables the use of a lower performance data processor, one that typically will require less power to operate. Furthermore, the data throughput of the overall embedded processing system is increased. In addition, the responsivity of the data processor for time critical operations is improved, since at least some data sorting and copying operations are off-loaded to the DMA controller.

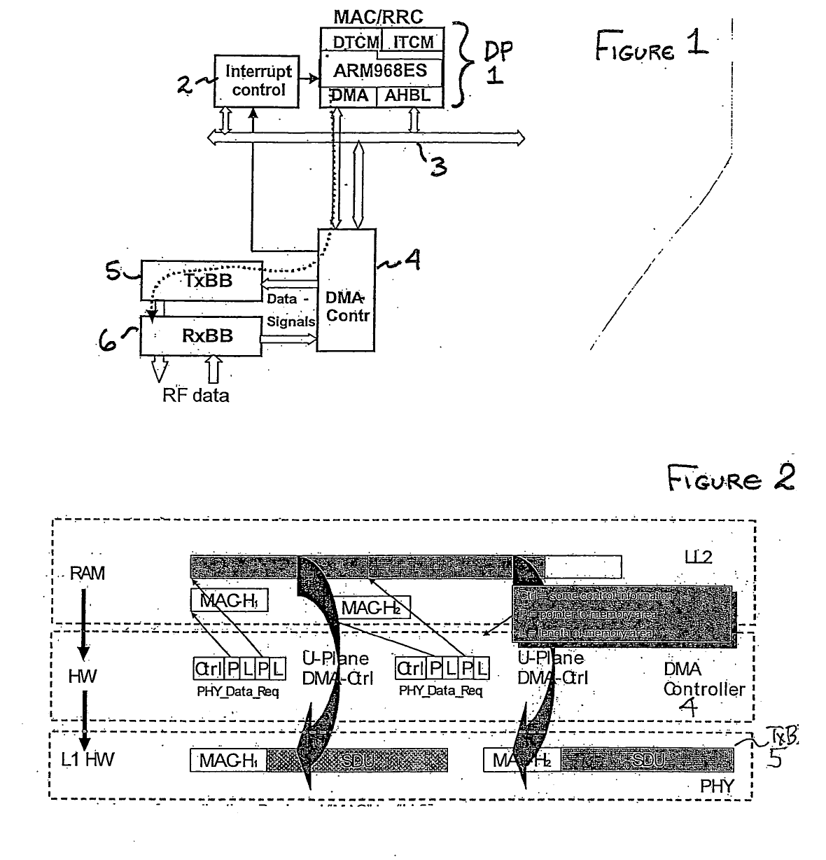

Referring to FIG. 1, there is shown an exemplary and non-limiting HW environment within which the exemplary embodiments of this invention may be practiced. In this non-limiting example, the HW environment is one found within a wireless communications device, such as a cellular phone. Illustrated in FIG. 1 is a data processor 1, that may be considered to be a MAC/RRC block containing a data processor 1. In this non-limiting and exemplary embodiment, the data processor is implemented with a commercially available data processor known as an ARM968E-S™ device. Shown in FIG. 1 as part of the ARM968E-S™ device is a Data Tightly Coupled Memory (DTCM) and an Instruction Tightly Coupled Interface (ITCM), and an AHBL bus interface. The AHBL interfaces the ARM968E-S™ to a system bus 3. The DMA port bypasses the system bus 3 and interfaces to an external (user plane) DMA controller 4 that is coupled via data busses to a Tx BB block 5 and to a RX BB block 6. RF data (transmit and receive) is coupled to the respective Tx and Rx blocks 5 and 6 from RF circuitry including modulators and demodulators (not shown), in a conventional fashion. It is explicitly noted that the illustration of a DMA port for accessing memory is exemplary and non-limiting.

It is again noted that the particular data processor 1 shown in FIG. 1 and described above is but one example of many different types of data processors, data processor architectures and data bus systems that may be used to implement the exemplary embodiments of this invention, and is no way intended to represent any limitation on the practice, use and construction of the exemplary embodiments of this invention.

With reference to FIG. 7, there is illustrated a flow chart of an exemplary embodiment of the invention. At Step A, a data block header is constructed and stored in a portion of a memory. As described more fully below, the data block header is associated with a payload block stored elsewhere in memory. At Step B, a DMA controller 4 is programmed with control information as well as memory location information, such as memory pointers, regarding the location in memory of at least one data block header and associated payload block. At Step C, the DMA controller 4 is instructed to begin the serialization and transfer of the data unit formed of at least one data block header and an associated payload block. After instructing the DMA controller 4 to commence the transfer of data, there can optionally be performed, at Step D, a verification of the successful transfer of data.

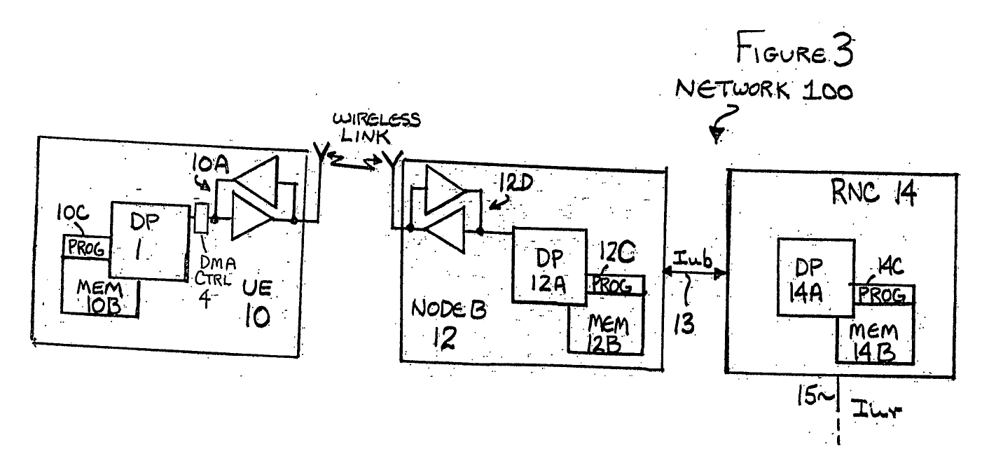

FIG. 2 illustrates the operation of the exemplary embodiments of this invention. The SW running on the data processor 1 (such as SW stored in the ITCM) constructs a data block (MAC) header (MAC-H) in a region of the RAM memory (in the DTCM in the example of FIG. 1) that is separate from a region where the payload block (SDU) is stored. In general, the MAC header will contain system and wireless network-specific information as defined in, as one non-limiting example, 3GPP TS 25.321, Section 9.2.1, while the SDU will contain, as non-limiting examples, digitized voice information or multi-media data (e.g., image data). The data processor 1 then programs the DMA controller 4 with the starting memory address (a pointer P) and the length (L) of the header and the payload block, respectively, as well any required control (Ctrl) information, depending on the specifics of the DMA controller 4. This Ctrl information will at least specify a destination for the data to be read from the RAM by the DMA controller 4 (the Layer 1 HW, or TxBB in this non-limiting example). At this point the data processor 1 instructs the DMA controller 4 to begin the data transfer. At the completion of the transfer, the DMA controller 4 can signal the Interrupt controller 2, which can then generate an interrupt to the data processor 1 to signal that the data block (MAC header and SDU) has been transferred from the RAM to the TxBB 5. From the TXBB 5 the data is transferred to the RF parts for use in modulating an RF carrier and subsequent transmission.

It can be noted that the use of the Interrupt controller 2 is not required, and that in some embodiments of this invention the data processor 1 may instead simply poll a status bit or bits of the DMA controller 4 to determine the state of the data transfer to the TXBB 5, as one non-limiting example.

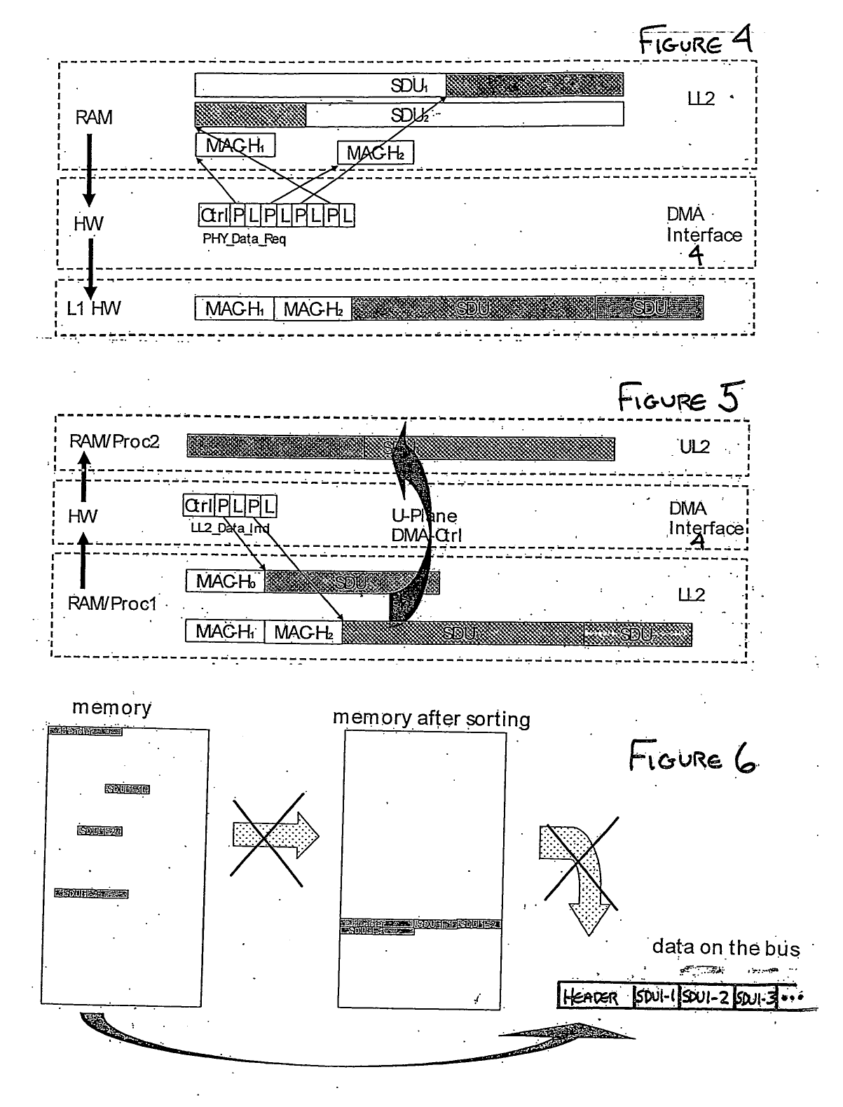

It should be noted that while FIG. 2 shows a simple case of one MAC header and one SDU, in practice there may be multiple MAC headers and multiple SDUs that are distributed into several blocks in the memory (for example due to segmentation of SDUs). FIG. 4 shows an example of a case where there exist in memory a plurality of MAC headers (MAC-H₁, MAC-H₂) and a plurality of SDUs (SDU₁, SDU₂). In principle the “instruction set” (defined herein for these purposes to be the pointer and length information given to the DMA Controller 4) can be of any length, giving any number of pointer-length tuples. Note that the DMA controller 4 need not be aware of the nature of the data being pointed to (e.g., MAC header(s), SDU(s)), and its operation can be totally independent of the type of data to be serialized.

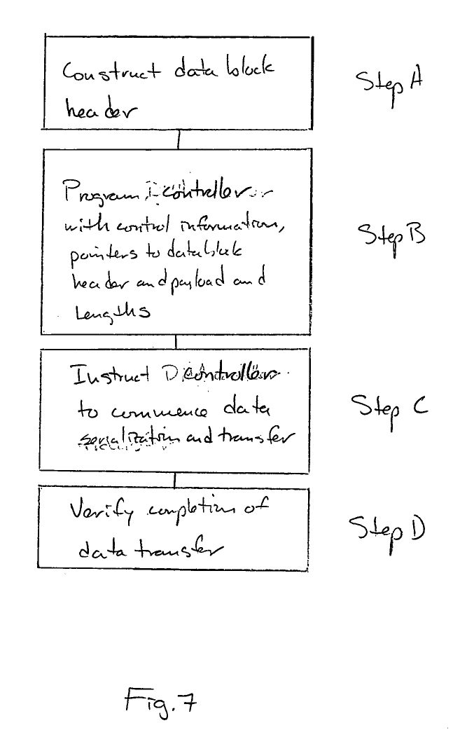

Reference in this regard may also be had to FIG. 6, where a memory is shown containing a header and multiple SDUs (SDU1-1, SDU1-2, SDU1-3). In the conventional approach the data processor would be required to perform data copying and sorting operations so as to arrive at the serialized configuration shown in the memory after the sorting operation in order to provide the correct sequence on the bus to subsequent HW, such as the TxBB 5. In contradistinction to this conventional approach, the use of the exemplary embodiments of this invention employs the DMA controller 4 to go directly from the case of the header and SDUs being scattered throughout memory to the bus data stream having the correct sequence of the header followed by SDU1-1, SDU1-2 and SDU1-3. Of course, more than one header block of data may be involved, and more than three SDUs can be involved as well.

During operation of the DMA controller 4, the DMA controller first reads from the RAM the MAC header(s), and then the SDU(s). These units of data are provided in the correct sequence to the TXBB 5. This flow is depicted by the dashed line in FIG. 1.

It can be noted that in accordance with the exemplary embodiments of this invention the data processor 1 is not required to sort the header and payload data in the RAM prior to transferring MAC data to the TXBB 4, as shown in FIG. 6. Instead, the data processor can maintain the header and payload data in separate regions of the RAM, and then simply program the DMA controller 4 to sequentially access the different regions of the RAM to thereby assemble a MAC-H with at least one corresponding MAC SDU.

Reference is made to FIG. 3 for illustrating a simplified block diagram of various electronic devices that are suitable for use in practicing the exemplary embodiments of this invention. In FIG. 3 a wireless network 100 is adapted for communication with a UE 10 via a Node B (base station) 12. The network 100 may include a RNC 14, which may be referred to as a serving RNC (SRNC). The UE 10 includes the data processor (DP) 1, a memory (MEM) 10B that stores data and a program (PROG) 10C, such as the DTCM and ITCM shown in FIG. 1, and a suitable radio frequency (RF) transceiver 10A for bidirectional wireless communications with the Node B 12, which also includes a DP 12A, a MEM 12B that stores a PROG 12C, and a suitable RF transceiver 12D. The Node B 12 is coupled via a data path 13 (lub) to the RNC 14 that also includes a DP 14A and a MEM 14B storing an associated PROG 14C. The RNC 14 may be coupled to another RNC (not shown) by another data path 15 (lur). The PROG 10C assumed to include program instructions that, when executed by the DP 1, enable the electronic device to operate in accordance with the exemplary embodiments of this invention, as was discussed above with relation to FIGS. 1 and 2. To this end, the DMA controller 4 is shown coupled between the DP 1 and the transceiver 10A, which is assumed in FIG. 3 to include the TX BB 5 and RX BB 6 circuitry shown in FIG. 1.

In general, the various embodiments of the UE 10 can include, but are not limited to, cellular telephones, personal digital assistants (PDAs), computers, image capture devices such as digital cameras, gaming devices, music storage and playback appliances, Internet appliances permitting Internet access and browsing, as well as units or terminals that incorporate combinations of such functions. These devices, units and terminals may or may not have wireless communication capabilities, and may or may not be portable.

The embodiments of this invention may be implemented by computer software executable by, as one example, the DP 1 of the UE 10, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 1, 12A and 14A may be of any type suitable to the local technical environment, and may include one or more of general purpose computers, special purpose computers, microprocessors, digital signal processors (DSPs), embedded DPs and processors based on a multi-core processor architecture, as non-limiting examples.

One advantage that is gained by the use of the invention is that it allows higher data throughput and better performance to be achieved by the DP 1. Another advantage is that since it conserves computing resources on the DP 1, it allows the use of a “lighter” processor that requires less integrated area and less power to operate.

Based on the foregoing it should be apparent that certain exemplary embodiments of this invention provide a method, apparatus and computer program product(s) to construct the constituent parts of a data unit in different regions of a memory, and to then use a DMA controller to correctly assemble the data unit from the constituent parts when transferring the data unit to a device or destination that will consume the data unit. The data unit can represent one or more MAC headers and one or more associated SDUs, as a non-limiting example.

The implementation of the exemplary embodiments of this invention is particularly useful with a MAC/PHY interface, although this should be viewed as but one exemplary application. Note further in this regard that the exemplary embodiments of this invention could be used instead in the Node B 12, or in both the Node B 12 and the UE 10. The exemplary embodiments of this invention could also be employed to advantage in other network elements, such as in the RNC 14.

Referring now to FIG. 5, it can be noted that the exemplary embodiments of this invention relate as well in a reverse direction of data flow. In this non-limiting case the DMA controller can be employed to move data (e.g., SDUs) from a lower layer (e.g., LL2) to an upper layer (e.g., UL2), such as when two protocol layers run on two different processors (Proc1, Proc2). Thus, the exemplary embodiments of this invention can be employed for inter-processor data transmissions as well, as one non-limiting example.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
constructing a data unit comprising a plurality of parts stored in a plurality of regions of a memory; and
instructing a controller to serialize said data unit and to transfer said data unit to a destination.

2. The method of claim 1 wherein said controller comprises a DMA controller.

3. The method of claim 1 wherein said data unit comprises at least one data block header comprising at least one of a system specific information and a wireless network specific information.

4. The method of claim 1 wherein instructing comprises programming said controller with control information and memory location information for each of said plurality of parts.

5. The method of claim 4 wherein said control information comprises destination information.

6. The method of claim 4 wherein said plurality of parts comprise at least one data block header and at least one payload block associated with said at least one data block header.

7. The method of claim 4 wherein programming further comprises programming said controller with length information for each of said plurality of parts.

8. The method of claim 1 additionally comprising verifying a completion of said transfer of said data unit.

9. A method comprising:
receiving an instruction to serialize a data unit comprising a plurality of parts stored in a plurality of regions of a memory;
serializing said data unit by reading out said plurality of parts in a predefined sequence; and
transferring said plurality of parts, in the predefined sequence, to a destination.

10. The method of claim 9 wherein said data unit comprises at least one data block header comprising at least one of a system specific information and a wireless network specific information.

11. The method of claim 9 wherein said instruction comprises control information and memory location information for each of said plurality of parts.

12. The method of claim 11 wherein said control information comprises a destination information.

13. The method of claim 11 wherein said plurality of parts comprise at least one data block header and at least one payload each associated with one of said at least one data block header.

14. The method of claim 11 wherein said instruction further comprises a length of each of said plurality of parts.

15. The method of claim 9 additionally comprising verifying a completion of said transfer of said data unit.

16. An apparatus comprising:
a processor; and
a memory coupled to the processor for storing a set of instructions, executable by the processor, for constructing a data unit comprising a plurality of parts stored in a plurality of regions of a memory, and instructing a controller to serialize said data unit by reading out said plurality of parts in a predefined sequence and to transfer said plurality of parts, in the predefined sequence, to a destination.

17. The apparatus of claim 16 wherein said controller comprises a DMA controller.

18. The apparatus of claim 16 wherein said data unit comprises at least one data block header comprising at least one of a system specific information and a wireless network specific information.

19. The apparatus of claim 16 wherein said instructing comprises programming said controller with control information and memory location information for each of said plurality of parts.

20. The apparatus of claim 19 wherein said control information comprises a destination information.

21. The apparatus of claim 19 wherein said plurality of parts comprise at least one data block header and at least one payload block each associated with one of said at least one data block header.

22. The apparatus of claim 19 wherein said instruction further comprises a length of each of said plurality of parts.

23. The apparatus of claim 16 further comprising a means for verifying a completion of the serialization of said data unit.

24. The apparatus of claim 16 comprising a network element in a wireless network.

25. The apparatus of claim 16 comprising a portable device.

26. A program of machine-readable instructions, tangibly embodied on an information bearing medium and executable by a digital data processor, to perform actions comprising:
constructing a data unit comprising a plurality of parts stored in a plurality of regions of a memory; and
instructing a controller to serialize said data unit and to transfer said data unit to a destination.

27. The program of claim 26 wherein said controller comprises a DMA controller.

28. The program of claim 26 wherein said data unit comprises at least one data block header comprising at least one of a system specific information and a wireless network specific information.

29. The program of claim 26 wherein said instructing comprises programming said controller with control information and memory location information for each of said plurality of parts.

30. The program of claim 29 wherein said control information comprises a destination information.

31. The program of claim 29 wherein said plurality of parts comprise at least one data block header and at least one payload each associated with one of said at least one data block header.

32. The program of claim 29 wherein said programming further comprises programming said controller with length information for each of said plurality of parts.

33. The program of claim 26 wherein said programming further comprises verifying the completion of the serialization of said data unit.

34. A network element comprising:
means for processing; and
means for storing a set of instructions, executable by the processing means, for constructing a data unit comprising a plurality of parts each stored in a different region of a memory, and instructing a controller to serialize said data unit and to transfer said data unit to a destination.

35. The network element of claim 34 wherein said instructing comprises programming said controller with control information, memory location information for each of said plurality of parts, and length information for each of said plurality of parts.

36. A method comprising:
constructing a data unit comprising at least two data blocks located in different regions of a memory;
programming a controller with control information and memory location and length information of said at least two data blocks; and
instructing said controller to perform a data transfer of said at least two data blocks in a predetermined sequence.

37. The method of claim 36 wherein said controller comprises a DMA controller.
